(19) United States
(12) Patent Application Publication
(10) Pub. No.: US 2014/0087711 A1
(43) Pub. Date: Mar. 27, 2014

(54) MOBILE DEVICE CONTEXT INCORPORATING NEAR FIELD COMMUNICATIONS

(71) Applicant: Aegis Mobility, Inc., Vancouver (CA)

(72) Inventors: John Joseph Geyer, Vancouver (CA); Stephen J. Williams, Port Moody (CA)

(73) Assignee: Aegis Mobility, Inc., Vancouver (CA)

(21) Appl. No.: 14/038,387

(22) Filed: Sep. 26, 2013

Related U.S. Application Data
(60) Provisional application No. 61/706,515, filed on Sep. 27, 2012.

(51) Int. Cl. H04W 4/00

(52) U.S. Cl. CPC H04W 4/008
USPC 455/418

(57) ABSTRACT

A communication environment includes of one or more subscriber terminals capable of receiving and transmitting data over a communication network via a communication management system. The communication management system receives mobile communication device context information based on near-field sensor information and mobile communication device identification information from the mobile communication device. The communication management system then processes the mobile communication device profile.

### CROSS-REFERENCE TO RELATED APPLICATION

This application claims the benefit of U.S. Provisional Application No. 61/706,515, entitled, MOBILE DEVICE CONTEXT INCORPORATING NEAR FIELD COMMUNICATIONS and filed on Sep. 27, 2012, which is incorporated herein by reference.

### BACKGROUND

Existing sensors all have their strengths and limitations. One general limitation is that the sensors do not necessarily provide specific information about a mobile subscriber's context. Rather, data from sensors such as GPS must be captured and interpreted in order to determine that the mobile subscriber is driving.

Additionally, some contextual states such as “in meeting” are not yet obtainable with the current state of the technical art, lack of physical deployment of required sensors within a building or shopping area and lack of a correspondingly accurate and available map of the building or shopping area.

Other handset OS or handset application developers my use short range wireless communications to determine a mobile subscribers context solely on the handset. While this approach may enable some services such as automatic check-in or ad delivery it does so in an “over-the-top” method, i.e. it does so without including the mobile network in the process of delivering contextually relevant information. The approach is limited as it excludes the ability for intelligent management of text and voice sessions as well as being more difficult if not impossible to deploy rapidly and widely to all handsets.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of one embodiment of a communication management environment including a communication management system and a number of mobile communication devices;

FIG. 2 is a block diagram illustrative of aspects of the communication management system of FIG. 1 in an embodiment of the communication management environment;

FIG. 3 is a block diagram illustrative of aspects of the mobile communication device of FIG. 1 in an embodiment of the communication management environment;

FIG. 4 is a block diagram of illustrating the transmission of mobile communication device context information by a mobile device and the processing by the communication management system;

FIG. 5 is a block diagram of illustrating the transmission of mobile communication device context information by a mobile device and the processing by the communication management system;

FIGS. 6A-6E are flow diagrams illustrative of travel state context assessment algorithm implemented by a mobile communication device in providing mobile communication device context information to a communication management system;

FIGS. 7A-7B are flow diagrams illustrative of a geospatial context assessment algorithm implemented by a mobile communication device in providing mobile communication context information to a communication management system; and

FIG. 8 is a flow diagram illustrative of a communication management routine implemented by a communication management system for managing communications according to mobile communication device context information.

### DETAILED DESCRIPTION

The present disclosure corresponds generally to mobile device management. More specifically, aspects of the present disclosure correspond to the utilization of close proximity radio communications, commonly referred to as Near Field Communication “NFC,” in the determination of contextual state of a mobile subscriber. In an illustrative embodiment, the utilization of various sensor data utilizing NFC communications can facilitate a call and session management system to more accurately detect when a mobile subscriber's context changes while helping to better preserve mobile device performance and battery life.

In one embodiment, NFC-enabled sensors can assist a call and session management system in determining a current mobile subscriber's context or whether a previously determined mobile subscriber's context has changed state. By way of illustrative example, in one embodiment, a mobile subscriber's context can be defined as corresponding to one of a set of potential mobile subscriber's contexts, including “driving,” “driver,” “passenger,” “bus rider,” “train rider,” “at home,” “at office,” “in theater,” or “shopping.” In another embodiment, a mobile subscriber's context can be defined in terms of whether NFC-enable sensor data is indicative that a mobile subscriber is within a specific geo-zone or at a specific geo-location. Still further, the NFC-enabled sensor data can be further utilized to calculate movement information, including rate and direction of movement of the mobile subscriber. In still other embodiments, a mobile subscriber's context can be defined in terms of a combination of potential mobile device context states, such as a selection from each of the two previously discussed embodiments.

In an illustrative call and session management system, the call and session management system operates by mediating call or session management as a function of a mobile subscriber's context as determined by algorithms running on the mobile device, within the mobile network or a combination of the two. With reference to a specific embodiment, illustratively, the communication management system can process mobile subscriber's context determined, at least in part, on receipt of NFC-enabled sensor data. Once a mobile subscriber's context is determined, the call and session management system assigns a specific rule or policy set for the mobile subscriber in each context. Once assigned, the call and session management system, through a server, then informs the appropriate network element including but not limited to the MSC, SMSC, PCRF, etc. Sessions can then be mediated by the network elements as instructed by the policy provided by call and session management system.

Although aspects of the system will be described to the drawings, flow diagrams, screen interfaces, and specific examples, one skilled in the relevant art will appreciate that the disclosed embodiments are illustrative in nature. Specifically, reference to specific wireless transmission protocols, illustrative context categories, or illustrative examples should not be construed as limiting should not be construed as limiting.

### System Overview

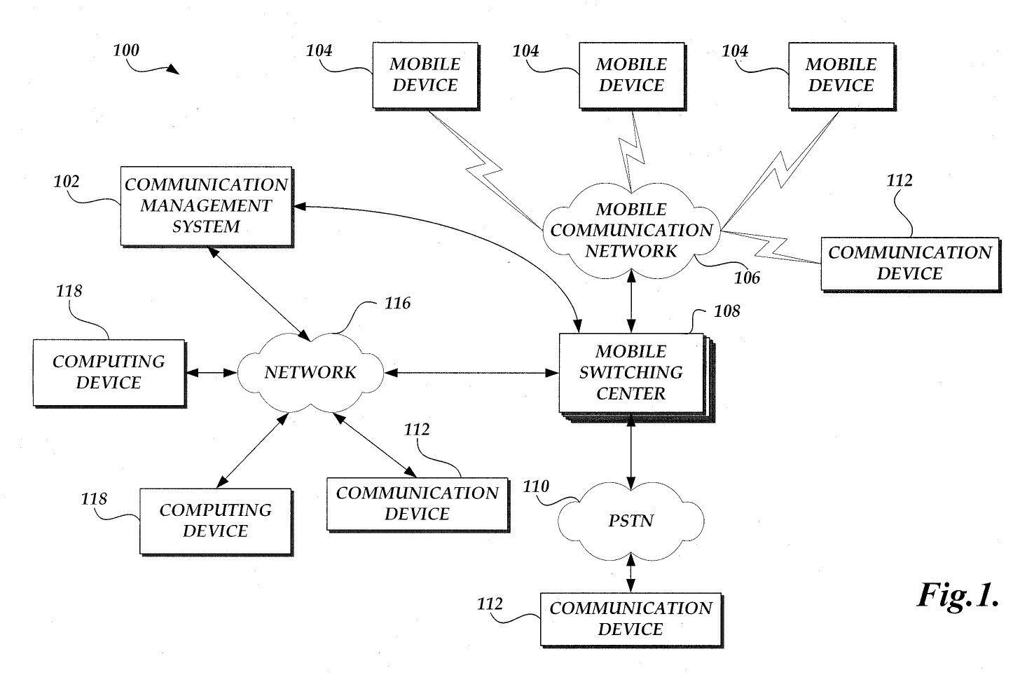

With reference now to FIG. 1, a block diagram illustrative of a communication management environment 100 for managing mobile subscriber's context will be described. As illustrated in FIG. 1, the communication management environment 100 includes a communication management system 102 for processing data communications and mobile subscriber's context. In one aspect, the communication management system 102 maintains mobile communication device profiles that are provisioned to establish the availability for the mobile communication device to receive and transmit data via a communication network based on a current context. In another aspect, the communication management system 102 can further process mobile subscriber context information to determine additional mobile device context states or to determine attributes of a mobile subscriber's device.

To manage requested communications, the communication management system 102 communicates with corresponding subsystems responsible for establishing wireless communication channels, such as mobile switching center 108. The communication management system 102 can communicate with the mobile switching center 108 via a direct communication connection, a secure communication channel via a communication network, such as communication network 114, or via a public communication network.

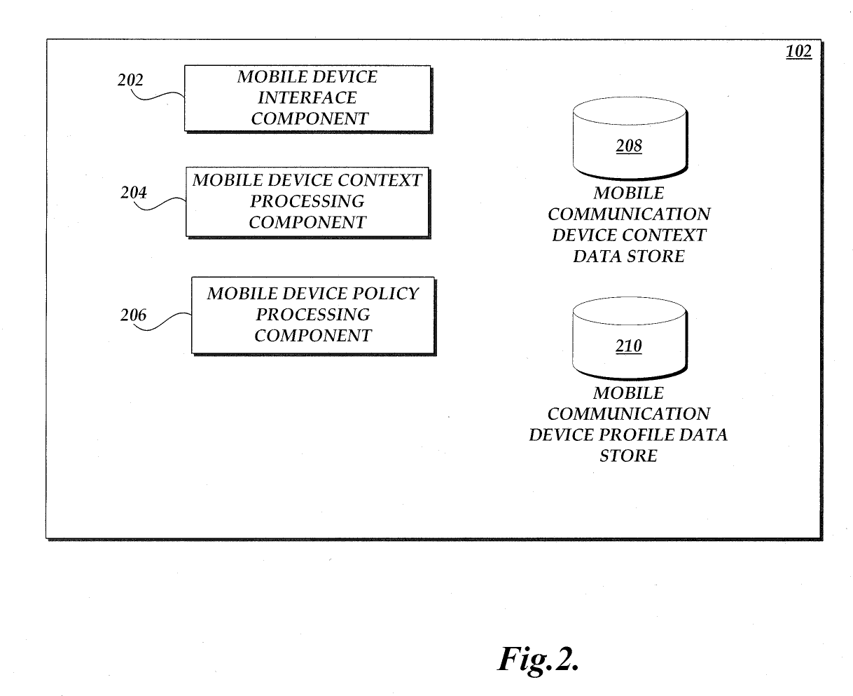

In an illustrative embodiment, the communication management system 102 provides data communication mitigation options in the event that the mobile communication device is unavailable to send or receive data communications. Still further, the communication management system 102 facilitates the generation of various graphical user interfaces for provisioning or managing mobile communication device profiles via computing devices 116. Illustrative components of the mobile communication management system 102 will be described in greater detail with regard to FIG. 2.

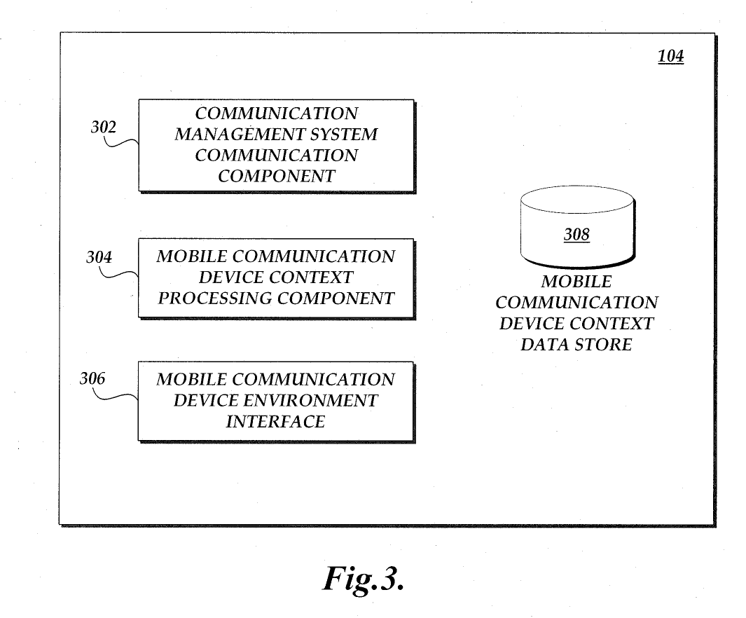

With continued reference to FIG. 1, the communication management environment 100 can include a number of mobile communication devices 104. The mobile communication devices 104 can correspond to wide variety of devices or components that are capable of initiating, receiving or facilitating communications over a communication network including, but not limited to, personal computing devices, hand-held computing devices, integrated components for inclusion in computing devices, home electronics, appliances, vehicles, and/or machinery, mobile telephones, modems, personal digital assistants, laptop computers, gaming devices, and the like. In an illustrative embodiment, the mobile communication devices 104 include a wide variety of software and hardware components for establishing communications over one or more communication networks, including wireless or wired mobile communication networks 106. The mobile communication devices 104 can be associated with one or more users for managing data communications according mobile communication device contexts. Illustrative components of a mobile communication device will be described in greater detail with regard to FIG. 3.

An illustrative communication management environment 100 can include a number of additional components, systems and/or subsystems for facilitating communications with the mobile communication devices 104 or the communication management system 102. The additional components can include one or more mobile switching centers 108 for establishing communications with the mobile communication devices 104 via the mobile communication network 106, such as a cellular radio access network, a wireless network based on the family of IEEE 802.11 technical standards (“WiFi”), a wireless network based on IEEE 802.16 standards (“WiMax”), and other wireless networks or wireless communication network standards. The operation of mobile communication networks, such as mobile communication network 106 are well known and will not be described in greater detail.

As illustrated in FIG. 1, the mobile switch center 108 includes interfaces for establishing various communications with via the communication network 116, such as the Internet, intranets, private networks and point-to-point networks. In one example, the mobile switch center 108 can include interfaces for establishing communication channels with various communication devices 112, such as landline telephones, via a public switched telephone network (PSTN) 110.

The mobile switch center 108 can also include interfaces for establishing communication channels with various communication network-based communication devices 112, such as a VoIP communication device. Still further, the mobile switch center 108 can include interfaces for establishing communication channels with a mobile-based communication device 112, such as another mobile communication device. For example, the communication devices 112 can correspond to a third-party mobile communication that establishes an audio communication channel with a mobile communication device 104. Accordingly, although communication network 116 is illustrated as a single communication network, one skilled in the relevant art will appreciate that the communication network can be made up of any number of public or private communication networks and/or network connections.

The various communication devices 112 can include the hardware and software components that facilitate the various modes of operation and communication, such as via wired and wireless communication networks. Additionally, the computing devices 118 can include various hardware and software components, such as a browser software application, that facilitate the generation of the graphical user interfaces for provisioning and managing mobile communication device profiles as will be described below.

One skilled in the relevant art will appreciate that the components and configurations provided in FIG. 1 are illustrative in nature. Accordingly, additional or alternative components and/or configurations, especially regarding the additional components, systems and subsystems for facilitating communications may be utilized.

With reference now to FIG. 2, illustrative components for the communication management system 102 will be described. Although the operation of the various functions associated with the communication management system 102 will be described with regard to below subcomponents, one skilled in the relevant art will appreciate that the subcomponents are illustrative in nature. Illustratively, the communication management system 102 may be associated with computing resources such as central processing units and architectures, memory (e.g., RAM), mass storage or persistent memory, graphics processing units, communication network availability and bandwidth, etc. Generally, however, the communication management system 102 may include one or more processing units, such as one or more CPUs. The communication management system 102 may also include system memory, which may correspond to any combination of volatile and/or non-volatile storage mechanisms. The system memory may store information that provides an operating system component, various program modules, program data or other components. The communication management system 102 performs functions by using the processing unit(s) to execute instructions provided by the system memory. The communication management system 102 may also include one or more types of removable storage and one or more types of non-removable storage. Still further, the communication management system 102 can include communication components for facilitating communication via wired and wireless communication networks, such as communication network 116. Accordingly, a communication management system 102 may include additional components or alternative components to facilitate one or more functions. Additionally, although the various subcomponents are illustrated as integrated into a communication management system 102, one or more of the components may be implemented in a distributed manner over a communication network and/or be implemented as a network service, e.g., a Web service.

As illustrated in FIG. 2, the communication management system 102 includes a mobile device interface component 202 for establishing communications with a mobile communication device 104. In an illustrative embodiment, the mobile device interface component 202 corresponds to a component for facilitating the bi-lateral transfer of data, such as mobile device context information, context assessment algorithms, etc., between the mobile communication device 104 and the communication management system 102. The mobile device communication component 202 can include software and hardware components necessary to establish one or more communication channels corresponding to various communication protocols such as Bluetooth, the family of IEEE 802.11 technical standards (“WiFi”), the IEEE 802.16 standards (“WiMax), short message service (“SMS”), voice over IP (“VoIP”) as well as various generation cellular air interface protocols (including, but not limited to, air interface protocols based on CDMA, TDMA, GSM, WCDMA, CDMA2000, TD-SCDMA, WTDMA, LTE, OFDMA and similar technologies).

The communication management system 102 can also include a mobile communication device context processing component 204. In one aspect, the mobile communication device context processing component 204 can determine the availability of a mobile communication device 104 for communication based on processing mobile communication device context information according to a mobile communication device profile. The mobile communication device context processing component 204 can execute various processes or algorithms for processing transmitted mobile communication device context information to determine mobile communication device availability to transmit or receive data. Additionally, the mobile communication device context processing component 204 can also manage the various context assessment processes or algorithms and updates to existing previously stored context assessment processes and algorithms that are transmitted and executed by the mobile communication devices 104.

With continued reference to FIG. 2, the communication management system 102 can include a mobile communication device policy processing component 206 for processing mobile subscriber's context policies. Illustratively, the mobile communication device policy processing component 206 can process requests for establishment of communication channels or maintenance of established communication channels based on evaluation one or more context policies. Additionally, the mobile communication device policy processing component 206 can evaluate mobile subscriber's context information to determine additional context states or to make additional assessments about the mobile subscriber's device. For example, the mobile communication device policy processing component 206 can process successive mobile subscriber context information to determine location or movement attributes for mobile subscriber devices.

With continued reference to FIG. 2, the communication management system 102 can also include a mobile communication device context data store 208 for maintaining mobile communication device context information previously transmitted by the mobile communication devices 104 or for maintaining the mobile communication device context assessment algorithms utilized by the mobile communication devices to process inputs into mobile communication device context. In one embodiment, the mobile communication device context information may be accessible, or otherwise published, to other computing devices, network based services, or users via the communication network 114.

The communication management system 102 can further include a mobile communication device profile data store 210 for maintaining mobile communication device profiles. The mobile communication device profile data store 212 may be one or more databases configured to provide the communication processing component 204 required data to determine mobile communication device data filter templates based on mobile communication device context. As will be described in greater detail below, the mobile communication device profile data defines the availability of the mobile communication device 104 to receive or transmit data as a function of a current mobile communication device context.

With reference now to FIG. 3, illustrative components for the mobile communication device 104 will be described. Although the operation of the various functions associated with the mobile device 104 will be described with regard to below components, one skilled in the relevant art will appreciate that the components are illustrative in nature. Accordingly, a mobile device 104 may include additional components or alternative components to facilitate one or more functions. Additionally, although the various subcomponents are illustrated as integrated into a mobile device 104, one or more of the components may be implemented in a distributed matter over a communication network and/or be implemented as a network service, e.g., a Web service.

As illustrated in FIG. 3, the mobile device 104 includes a communication management system communication component 302 for facilitating communications with the communication management system 102. As described above with regard to the mobile device communication component 202 (FIG. 2), the communication management system communication component 302 facilitates the bi-lateral transfer of data between the mobile communication device 104 and the communication management system 102. One skilled in the relevant art will appreciate that the communication management system communication component 302 can include software and hardware components necessary to establish one or more communication channels corresponding to various communication protocols for establishing the bi-lateral communication channels. Moreover, although the communication management system communication component 302 is illustrated as a separate component, the functionality of the component may be integrated, or otherwise combined, with one or more hardware or software components utilized by the mobile communication device 104 to make communication channels (e.g., cellular communication channels or SMS communication channels as part of the designed function of the mobile device).

As will be described in greater detail below, the communication management system communication component 302 transmits current mobile device context information in accordance with the context assessment algorithms on the mobile device 104. Once a current mobile communication device context is established, the communication management system 302 can limit additional transmission of context information upon detection of a change in mobile communication context information. Additionally, in an alternative embodiment, the communication management system communication component 302 may also transmit, or otherwise publish, mobile communication device context information to additional recipients, such as communication network resources such as Web sites or network services, and/or to other peer destinations.

The mobile communication device 104 can also include a mobile communication device context information component 304 for processing a set of inputs corresponding to a mobile device environment to determine mobile device context information. Illustrative context assessment algorithms or processes for determining mobile device context information will be described in greater detail below. The mobile communication device contexts can identify or describe aspects of the mobile communication device 104, aspects of the mobile communication device environment, and/or aspects of the user associated with the mobile communication device. For example, the mobile communication device context corresponds to a determination of various states of movement/travel, such as in a non-transitory state, an in-transit state (including city/urban travel transit, highway transit, and in-flight transit states), a journey onset state and a journey termination state. In another example, the mobile communication device context corresponds to a determination of whether a mobile communication device's present location is within a geospatial boundary, also referred to as geofencing (including within the geospatial boundary, on a border of the geospatial boundary, or outside the geospatial boundary). One skilled in the relevant art will appreciate that the identified mobile device contexts are not exhaustive and that any number of additional mobile device contexts, or variations of the identified mobile communication device contexts, may also be defined for the mobile communication device 104. An illustrative system and methodologies for determining mobile communication device context or processing mobile communication device context information is described in co-pending and commonly assigned U.S. application Ser. No. 12/040,832, entitled MANAGEMENT OF MOBILE DEVICE COMMUNICATION SESSIONS TO REDUCE USER DISTRACTION, and filed on Feb. 29, 2008, which is incorporated herein by reference.

With continued reference to FIG. 3, the mobile communication device 104 can also include a mobile communication device environment interface 306 for obtaining inputs corresponding to a mobile communication device environment. In an illustrative embodiment, the set of inputs can include information from one or more sensors that are capable of transmitting information or obtaining information based on NFC signals. Generally described, NFC may correspond to one of several radio frequency standards defining communication protocols and data exchange formats. Examples of NFC standards include, but are not limited to, the International Organization for Standards (“ISO”) 1443, ISO 18092 standards, as well as additional standards promulgated by one or more standards organizations. Illustrative sensors that may be able to have NFC capability include accelerometers, altimeters, compasses, gyroscopes, microphones, scales or other weight detection mechanisms, range finders, proximity sensors, gas or radiation detectors, electric current or electric induction detection, digital image sensors, thermometers and the like. Additionally, the set of inputs can correspond to one or more sensors that provide information to the mobile communication device separate from an NFC-based communication. Still further, the set of input can correspond to information obtained from communication network based resource such as calendaring information, identity or contact information and the like.

Illustratively, a set of NFC-enabled sensors can operate in either active or passive mode. In this example, one sensor can correspond to a role referred to as “Initiator” while a second sensor can correspond to a role entitled “Target.” In an active mode, both the Initiator and Target devices generate their own alternating radio frequency fields and generally both devices have power supplies. In a passive mode, an Initiator device provides a carrier field and the Target device answers by modulating the existing field and acts as a transponder.

One skilled in the relevant art will appreciate that the set of inputs may be selected to correspond specifically to the particular algorithms utilized to calculate mobile communication device context. In one example, microphonic sensors may be used for detecting high noise levels from the embedded device microphone and using this context to permit only high importance work related calls and data session requests that pertain to the current work function. In another example, the sensor information can corresponds to a determination whether a Bluetooth headset or alternative hands free device is active in accordance with a corporate policy and local jurisdiction law.

In still another example, proximity sensor information could be used to determine a context that the user is currently interacting in a specific manner with the mobile end device may enable specific call and data session management decisions to be critically enabled. In a further example, image data from a mobile device camera may be utilized via signal context assessment algorithms to determine the user's environment. In another example, user configurable keys/control sensor data can be utilized to customize mobile device context information, such as using soft keys, to register specific contexts provided by the mobile communication device user (e.g., “watch me,” “help,” etc.).

The mobile communication device 104 can further include a mobile communication device data store 308 for storing input information from the mobile communication device environment interface 306, context information generated by the mobile communication device processing component 304 or the various context assessment algorithms or processes used by the mobile communication device processing component to generate the mobile communication device context information.

### Mobile Communication Device Data Processing

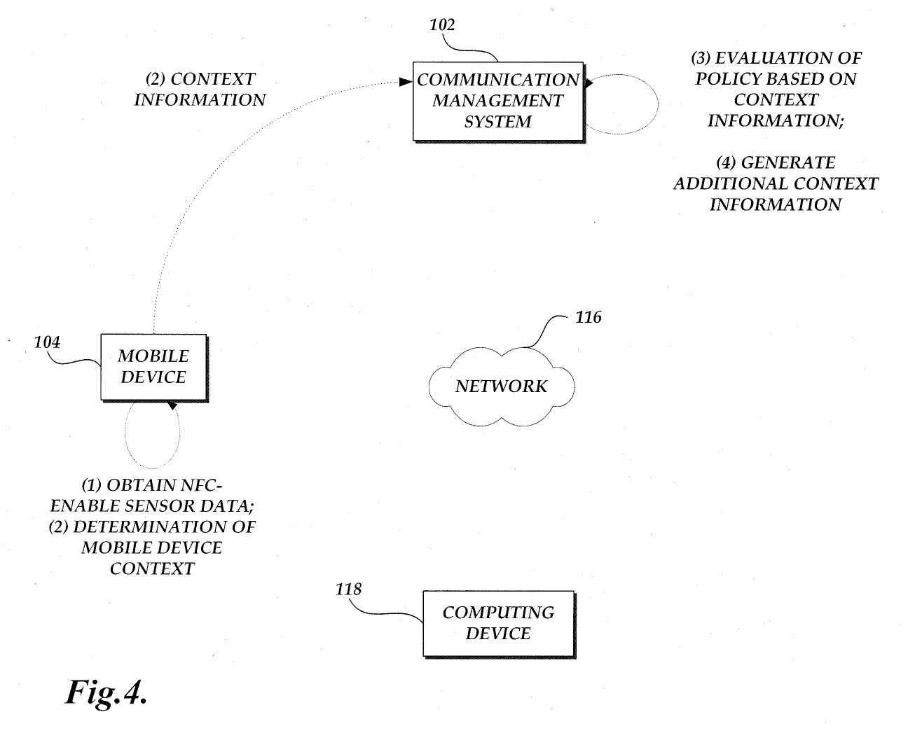

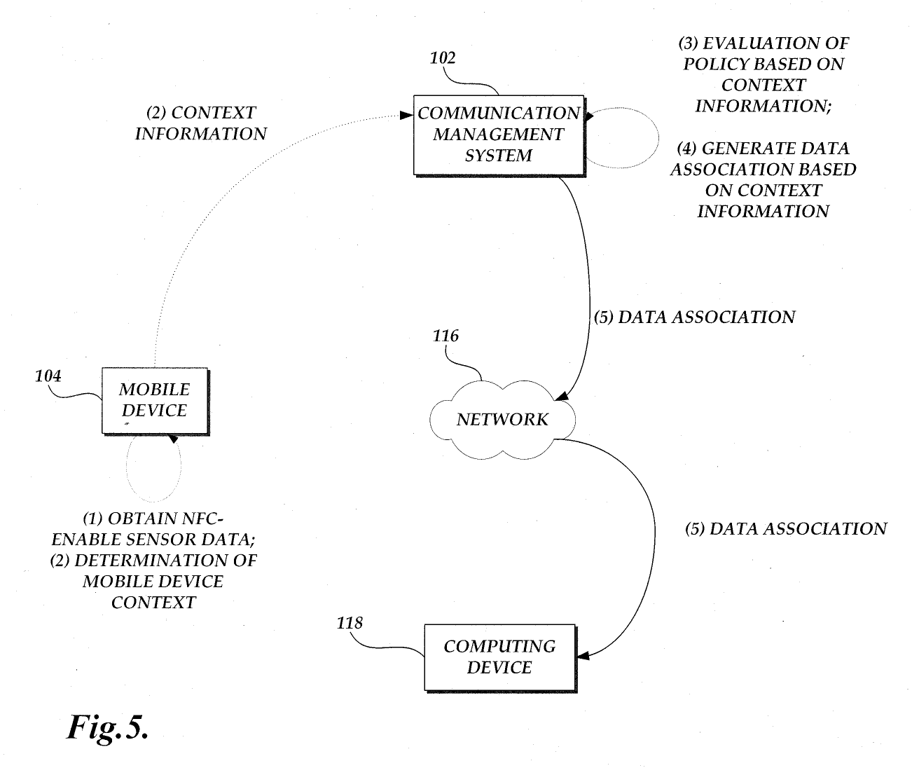

With reference now to FIGS. 4-5, the interaction between various components of the communication management environment 100 of FIG. 1 will be illustrated. For purposes of the example, however, the illustration has been simplified such that many of the systems, subsystems and components utilized to facilitate communications are not shown. One skilled in the relevant art will appreciate that such components or subcomponents can be utilized and that additional interactions would accordingly occur without departing from the spirit and scope of the present invention.

As illustrated in FIG. 4, at (1), during the operation of the mobile communication device 104, or during an initialization of the mobile communication device, the mobile communication device interface component 306 obtains a set of inputs corresponding to the mobile communication device environment. Illustratively, the set of inputs corresponds to at least one NFC-enabled sensor that obtains or generates context data. In one embodiment, the NFC-sensor data can correspond to interaction with one or more sensors on physical premises or devices that can be associated with a geographic zone. For example, an NFC-sensor incorporated in a mobile communication device 104 may interact with a NFC sensor in a building or room to establish the presence of the mobile communication device. By way of example, the NFC-sensor may interact with a sensor mounted on the entry-way of a building, conference room, restaurant, queue and the like. In another example, the NFC-sensor data incorporated in a mobile communication device 104 may interact with other mobile communication devices to establish a proximity to other individuals. The NFS-sensor information can be independent of any additional sensors associated with the mobile telecommunication device, such as GPS sensors, accelerometers, etc.

The set of inputs are processed by the mobile communication device context processing component 304 to generate mobile communication device context information. In one embodiment, the processing of the set of inputs to determine context may correspond to a direct association of NFC-sensor data to a specific context. For example, the detection of a sensor associated with public transportation (e.g., bus, taxi, train, etc.) may be automatically associated with a particular context, such as driving. In another example, the detection of a sensor associated with purchasing or point of sale terminals may correspond to a geographic context based on the denomination of currency exchanged in a transaction (e.g., an exchange in Canadian dollars may indicate a geographic context of Canada). In still a further example, the detection of specific geographic identifiers associated with another sensor may be interpreted to establish a context related to security or privacy. With regard to this example, a detection of an NFC-sensor in a laboratory, bathroom or other areas that may be associated with restrictions may automatically be associated with a security context by the mobile communication device 104.

In other embodiments, the processing of the set of inputs to determine context may correspond to an indirect association of NFC-sensor data to a specific context. For example, the detection of a geographic identifier associated with another sensor may be interpreted to establish a context, such as determining whether an individual is in violation of parole or travel restrictions based on geographic limitations.

In still further embodiments, the mobile communication device 104 can utilize multiple inputs to determine one or more contexts. For example, the mobile communication device 104 may obtain scheduling information, such as from electronic mail or calendaring applications to verify whether a detected presence via an NFC-enabled conference room correspond to a planned meeting. Similarly, the mobile communication device 104 can further review calendaring information or correspondence to determine whether a grouping of NFC-enable mobile devices associated with users corresponds to a planned meeting or distribution list. With reference to another previously provided example, in embodiments in which a specific currency or change in currency is detected, the mobile communication device 104 can utilize additional GPS data to verify location or a change in location. Such interaction may allow the mobile communication device 104 to better manage power consumption on the mobile communication device, by limiting times in which GPS data is required or processed.

At (2), the communication management system communication component 302 than transmits the mobile communication device context information to the communication management system 102 as appropriate. Specifically, to reduce power consumption or bandwidth consumption, the communication management system communication component 302 may limit the transmission of mobile communication device context information for the initialization of a mobile communication device context, a detection of a change in mobile communication device context and/or for the re-establishment of a mobile communication device context.

Upon receipt of the context information, the mobile device interface component 202 transmits the context and identification information to the mobile communication device context processing component 204 for processing. At (3), the mobile communication device context processing component 204 obtains a corresponding, or applicable, mobile communication device profile from the mobile communication device profile data store 210. In one embodiment, communication processing component 204 may utilize the selected mobile communication device profile to determine mobile communication device data availability from the context information. Based on the mobile communication device profile selected according to the context, the mobile communication device policy processing component 206 can determine the availability to establish communication channels, establish data filters corresponding to the policy (and specified actions), or other actions.

In another embodiment, the mobile communication device context processing component 204 can further generate additional context information regarding the mobile communication device 104. Illustratively, the mobile communication device context processing component 204 can establish the current context information (e.g., a particular conference room, building, road, or other geographic identifier) to calculate directional and rate of movement over a period of time. In this example, the context of the mobile communication device 104 may not correspond to the same type of NFC-sensor. For example, a mobile communication device 104 can establish a context related to interaction with point of sale terminals, conference rooms, information kiosks, etc. that can be processed into location, directional and rate of travel information.

With reference now to FIG. 5, in another embodiment, the mobile communication device 104 and the communication management system 102 may interact in a manner as illustrated in FIG. 4. As illustrated in FIG. 5, in this embodiment, at (5), the communication management system 102 can generate additional data associations based on context. The additional data associations may utilize the mobile communication device 104 context to establish additional information for delivery to third parties, such as via computing device 118. In one embodiment, the additional data associations may provide a summary of a group of individuals that may be logically associated based on proximity to one another. For example, the communication management system 102 may logically associate all mobile communication devices that are capable of interacting together via NFC-sensors. In another embodiment, the communication management system 102 may utilize additional data associations related to completed transactions at point of sale terminals or kiosks to indicate a consumer that may be in a position to make additional purchases or transactions.

### Mobile Device Context Assessment Algorithms

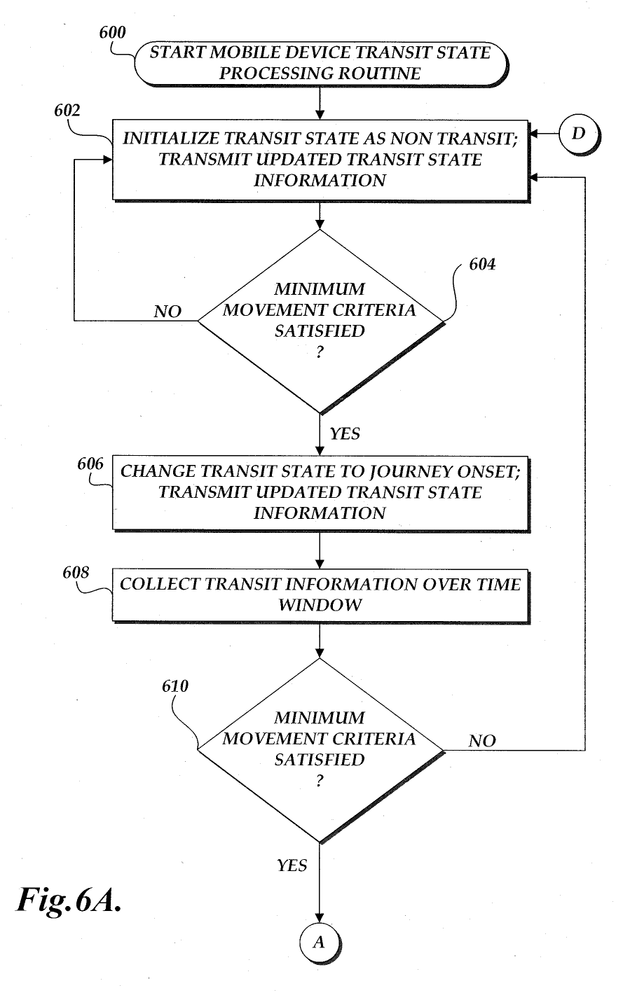

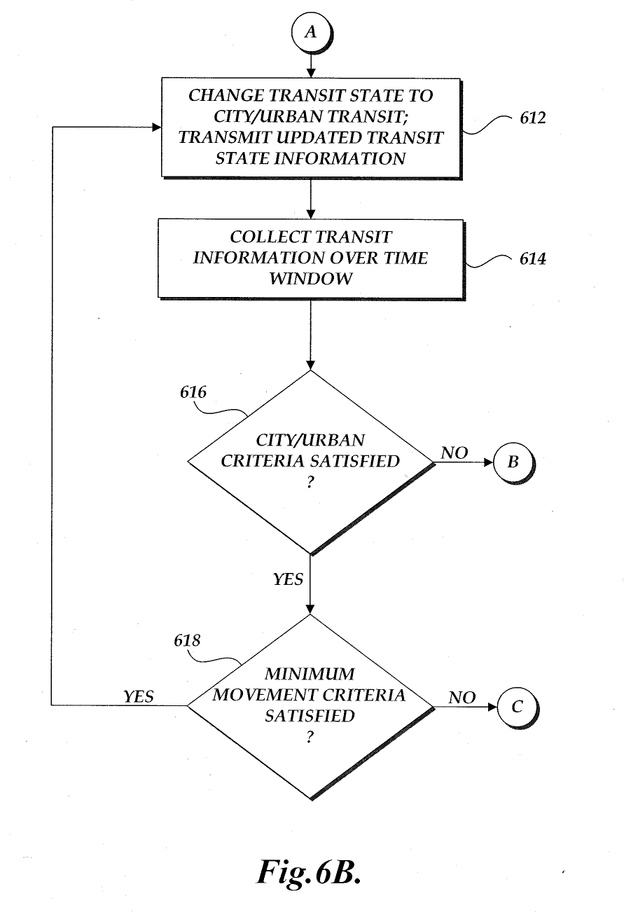

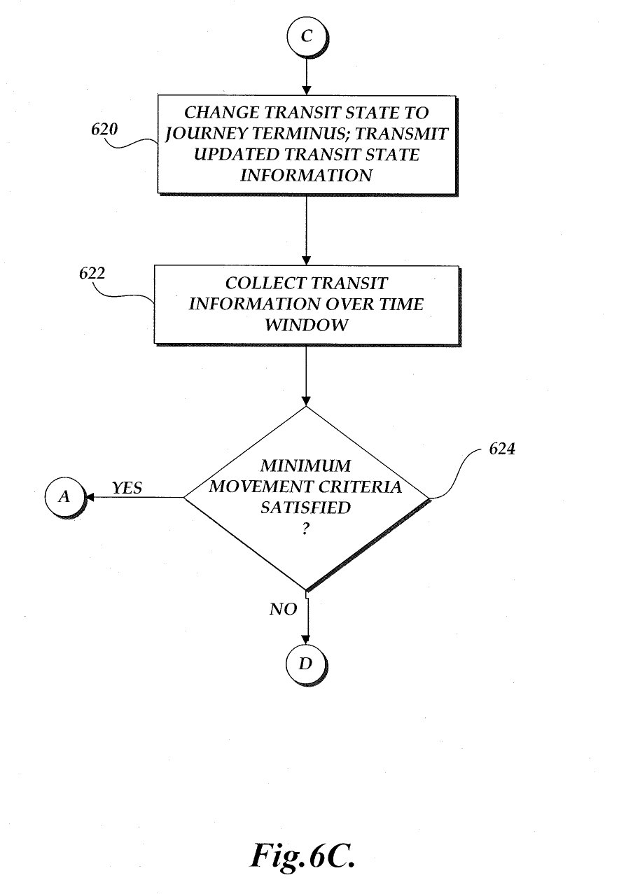

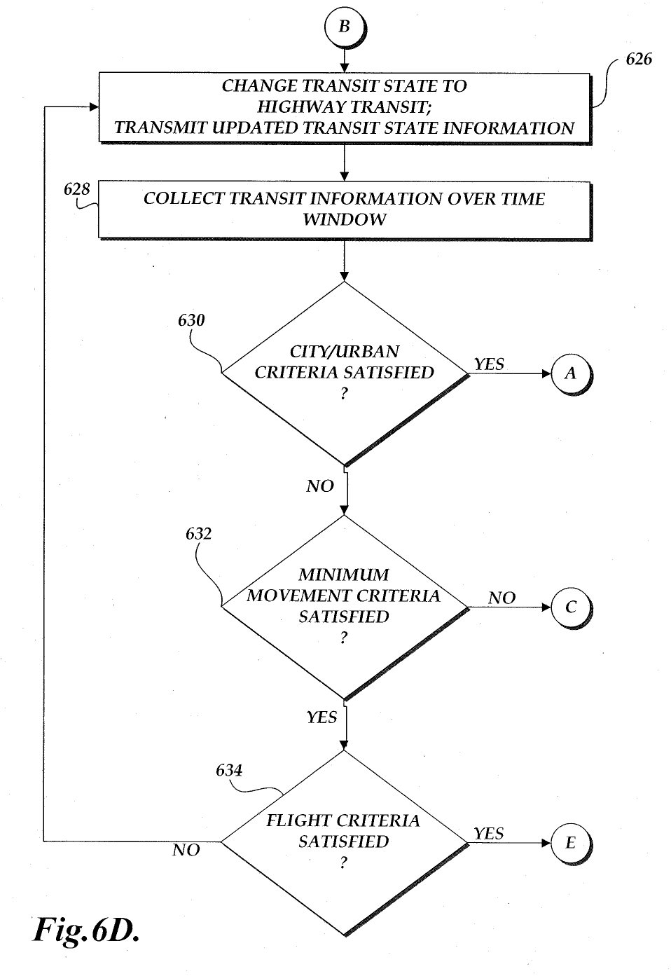

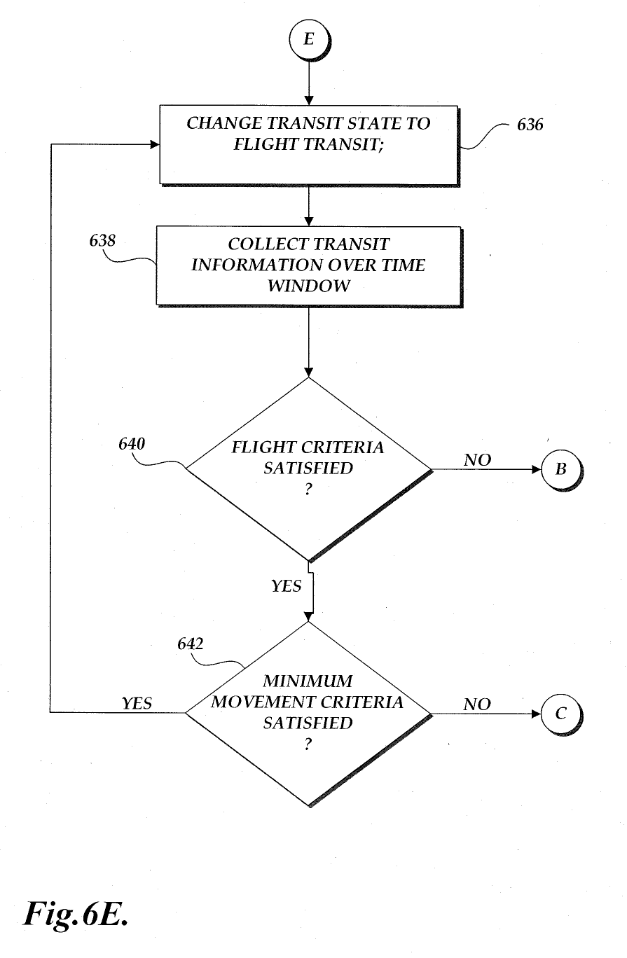

With reference now to FIGS. 6A-6E, an illustrative routine 1200 implemented by the mobile communication device context processing component 304 for determining context information of a mobile communication device 104 will be described. As described above, the mobile communication device context can correspond to a determination of a specific transit state indicative of a current mobile communication device environment, such as based on NFC-sensor data obtained by the mobile communication device 104. The availability for a data communications may be based on the determined transit state and the appropriate mobile communication device profile. With reference to FIG. 6A, at block 602, the routine 600 begins with the initialization of the transit state to non-transit by the mobile communication device context processing component 304. In an illustrative embodiment, the non-transit state is a first state indicative of when the mobile communication device 104 is powered on or begins tracking transit state. The initialization of the transit state to non-transit may be transmitted to the communication management system 102 or may be assumed as the starting context for the mobile communication device 104.

At decision block 604, a test is conducted to determine whether minimum movement criteria have been satisfied based on processing the set of inputs. For example, the test can correspond to a review of velocity input(s) and distance traveled input(s) to determine whether the input values exceed a minimum threshold. In one embodiment, velocity and distance information can be obtained by the mobile communication device through a variety of sensors and/or components designed to generate or calculate such information. Examples include, but are not limited to, GPS devices/components, accelerometers, navigational equipment and the like. As previously described, the sensors and/or components may be integrated into the mobile communication device 104 or may be separate components (e.g., a car navigation system) that provide the input information via a wired or wireless connection.

In another example, the velocity and distance information may be calculated by the mobile communication device 104 through by the utilization of recognizable or detectable objects. In accordance with this example, the mobile communication device 104 receives signals generated by fixed transmitters, such as cellular communications base stations or WiFi wireless nodes, which generally include some identification information specific to the particular transmitter, such as an SSID for a wireless node. As a mobile communication device 104 travels, signals from specific transmitters are detected when the mobile communication device is within range of the transmitter and no longer detected when the mobile communication device is beyond the range of the transmitter. For known communication ranges of transmitters, such as WiFi wireless nodes, velocity and distance traveled information may be calculated based on monitoring time from the detection of a signal from a transmitter to loss of the signal. Additionally, the detection of the signal from the transmitter would not require registration with the transmitter and could still be practiced with transmitters that restrict access, such as through encrypted transmissions. Still further, the mobile communication device 104 can utilize NFC-sensor information to calculate velocity or distance information in a manner described above. Alternatively, the mobile communication device 104 can utilize a third-party service to calculate velocity or distance information based on NFC-sensor data.

If the minimum movement criteria have not been satisfied, it is assumed that the mobile communication device (considering its environment) is still in a non-transit state and the routine 600 returns to block 602. The routine 600 may continue to loop through this portion for any amount of time.

Alternatively, if the minimum movement criteria have been satisfied, it is assumed that the mobile communication device 104 (considering its environment) is in motion, and at block 606, the transit state is changed to a “journey onset state.” Because the transit state has changed, the mobile communication device 104 may transmit updated context information to the communication management component 102 indicative of the change in transit state to a journey onset state. At block 608, the mobile communication device context processing component 304 enters an observation window for collecting the various inputs over a period of time. The observation window can be configured such that the mobile communication device 104 collects a fixed number of sets as defined by an information collection interval over a time period. Each time a set of inputs is collected a counter is decremented and the process continues until the targeted number of sets on inputs have been collected (e.g., the counter is decremented to a value of “0”). Additionally, if the mobile communication device environment interface 306 is currently not receiving inputs, or otherwise not accepting inputs, the mobile communication device 104 may enter a lower power consumption mode in which one or more components of the mobile communication device 104 become inactive or enter in a low power consumption mode of operation. In turn, the mobile communication device 104 then powers up, or wakes up, at the next information collection interval. The specific information collection interval implemented by the mobile communication device context processing component 304 may be dependent on the granularity of the sensor information, the amount of input information that should be collected for a given transit state, and/or the likelihood of a potential change in transit state. For example, a longer collection interval can be set for transit states in which variations in the set of inputs is not expected (e.g. a highway transit state) to further conserve mobile communication device power.

Upon the expiration of the time window, at decision block 610, a test is conducted to determine whether minimum movement criteria have been satisfied based on processing the set on inputs. If the minimum movement criteria have not been satisfied, the mobile communication device 104 is determined to be no longer in motion and the routine 600 returns to block 602 to a “non-transit” travel state (described above). Because the transit state has changed, the mobile communication device 104 may transmit updated context information to the communication management component 102 indicative of the change in transit state back to a non-transit state.

With reference now to FIG. 6B, alternatively, if at decision block 610 (FIG. 6A), the minimum movement criteria have been satisfied, at block 612, the mobile communication device 104 is determined to be in motion and the transit state is changed to a “city/urban” transit state. In an illustrative embodiment, the city/urban transit state can correspond to the driving conditions experienced in city or urban areas in which there are frequent stops and wide changes in velocity. Again, because the transit state has changed, the mobile communication device 104 may transmit updated context information to the communication management component 102 indicative of the change in transit state back to a non-transit state. At block 614, the mobile communication device context processing component 304 enters an observation window that defines a set of intervals for collecting multiple sets of inputs over a period of time. In a city/urban transmit state, the collection interval for receiving each set of inputs may be configured to be shorter because of the potential for greater variances in the information from set of inputs.

At decision blocks 616-618, the mobile communication device context processing component 304 processes the collected input data to determine whether the mobile communication device 104 should remain in its current city/urban transit state, whether the mobile communication device has reached a terminus state, or whether the transit state is more indicative of another transit state typically indicative of highway travel. The collected information can include velocity, bearing, and distance traveled information. Additionally, the collected information can include processed velocity, bearing and distance traveled information, referred to as variance information, that indicate variances and/or rates of variance in the velocity, bearing and distance traveled over each of the collection intervals in the observed time window.

At decision block 616, a test is conducted to determine criteria indicative of city/urban transit state have been satisfied. The criteria indicative of city/urban transit state can correspond to consideration of variance thresholds for velocity, distance traveled and bearing that are indicative of patterns of city/urban travel. For example, velocity variances for a city/urban transit state may be indicative of a collection of inputs at a time in which a vehicle is stopped (e.g., at a street light) and another collection when the vehicle is traveling at a higher velocity. The thresholds may be determined by observed driving behavior, set by an administrator or set by a particular user. If the criteria indicative of city/urban transit state have not been satisfied, the mobile communication device context processing component 304 determines that the mobile communication device 104 is not likely in a city/urban driving embodiment and moves to block 626, which will be described in greater detail below. Alternatively, if the criteria indicative of city/urban transit state have been satisfied, the mobile communication device context processing component 304 determines that the mobile communication device 104 should either remain in a city/urban travel state or has reached a terminus. Accordingly, at decision block 618, a test is conducted to determine whether minimum movement criteria have been satisfied based on processing the set on inputs. If the minimum movement criteria have not been satisfied, the mobile communication device 104 is determined to be no longer in motion and the routine 600 proceeds to block 620 (FIG. 6C). Alternatively, if the minimum movement criteria have been satisfied, the routine 600 returns to block 612. In this instance, however, the mobile communication device 104 does not need to transmit context information to the communication management component 102 because the transit state has not changed.

With reference now to FIG. 6C, at block 620, the transit state of the mobile communication device is changed to a “journey terminus” transit state. In an illustrative embodiment, the journey terminus transit state can correspond to the completion of the initial travel. As previously described, because the transit state has changed, the mobile communication device 104 may transmit updated context information to the communication management component 102 indicative of the change in transit state. At block 622, the mobile communication device context processing component 304 enters an observation window in which a collection interval may be set to a shorter time period because of the expectation for a higher variance between the sets of inputs at each collection interval.

Upon the completion of the observation window, the mobile communication device context processing component 304 will determine whether the mobile communication device has re-entered a travel state (e.g., after a temporary stop) or has entered a non-transitory state (e.g., at home or at the office). Accordingly, at decision block 624, a test is conducted to determine whether a minimum movement has been detected based on the set on inputs. If minimum movement has not been detected, the mobile communication device 104 is determined to be no longer in motion. Accordingly, the transit state is changed to “non-transitory” at block 602 (FIG. 6A). Alternatively, if a minimum movement has been detected based on the set on inputs, the mobile communication device 104 is determined to be in transit again and the routine 600 proceed to block 612 (FIG. 6B) in which the transit state is changed to city/urban transit state. In both decision alternatives, the mobile communication device 104 transmits updated context information to the communication management component 102 indicative of the change in transit state.

With reference now to FIG. 6D, if at decision block 616 (FIG. 6B), the criteria indicative of city/urban transit state were not satisfied, the mobile communication device context processing component 304 determines that the mobile communication device is a highway transit state, indicative of highway travel. Accordingly, at block 626, the transit state is changed to a “highway” traveled state and the mobile communication device 104 transmits updated context information to the communication management component 102 indicative of the change in transit state. At block 628, the mobile communication device context processing component 304 enters an observation window in which a collection interval may be set to a longer time period because of the expectation for a lower variance between the sets of inputs at each collection interval. When the mobile communication device 104 is a highway transit state, it can transition to a terminus state (e.g., indicative of a completion of travel), revert back to a city/urban transit state or remain in a highway transit state. Additionally, in an optional embodiment, the mobile communication device context processing component 304 can determine that the mobile communication device 104 is a flight state indicative of airplane travel. Accordingly, as will be illustrated in FIG. 6D, the mobile communication device context processing component 304 can also reach an “in flight” transit state from the highway traveled state. In all the decision alternatives involving a change in transition state, the mobile communication device 104 transmits updated context information to the communication management component 102 indicative of the change in transit state.

At decision block 630, a test is conducted to again determine whether criteria indicative of city/urban transit state has been satisfied. If the city criteria indicative of city/urban transit state has been satisfied, the mobile communication device context processing component 304 determines that the mobile communication device 104 should revert back to a city/urban travel state and the routine 600 returns to block 612 (FIG. 6B). Alternatively, if the criteria indicative of city/urban transit state has not been satisfied, the mobile communication device context processing component 304 determines that the mobile communication device 104 should either remain in the highway transit state, move to a journey terminus state, or move to an in-flight state. Accordingly, at decision block 632, a test is conducted to determine whether a minimum movement has been detected based on the set on inputs. If the minimum movement has not been detected based on the set on inputs, the mobile communication device 104 is determined to be no longer in motion and the routine 600 proceeds to block 620 (FIG. 6C).

If, however, at decision block 632, the minimum movement has been detected based on the set on inputs, at decision block 634, a test is then conducted to determine whether criteria indicative of an in-flight transit state has been satisfied. In an illustrative embodiment, criteria indicative of an in-flight transit state can correspond to consideration of variance thresholds for velocity, distance traveled and bearing that are indicative of patterns of air travel. The criteria may also include consideration of information from altimeters or the like. The thresholds may be determined by observed driving behavior, set by an administrator or set by a particular user. If the criteria indicative of an in-flight transit state has not been satisfied, the mobile communication device context processing component 304 determines that the mobile communication device should remain in a highway transit state and the routine 600 returns to block 626.

With reference now to FIG. 6E, if the criteria indicative of an in-flight transit state has been satisfied, the mobile communication device context processing component 304 determines that the mobile communication device is in flight. Accordingly, at block 636, the transit state is changed to an “in flight” transit state. At block 638, the mobile communication device context processing component 304 enters an observation window for collecting the various inputs over a period of time, which may be a longer time period. At decision block 630, a test is conducted to determine whether is conducted to determine whether one or more in flight distance variances have been exceeded. If the criteria indicative of an in-flight transit state has not been satisfied, the mobile communication device context processing component 304 determines that the mobile communication device 104 should revert back to a highway travel state and the routine 600 returns to block 626 (FIG. 6D). Alternatively, if the criteria indicative of an in-flight transit state has been satisfied, the mobile communication device context processing component 304 determines that the mobile communication device 104 should either remain in the in-flight distance transit state or move to a journey terminus state. Accordingly, at decision block 640, a test is conducted to determine whether a minimum movement has been detected based on the set on inputs. If the minimum movement has not been detected based on the set on inputs, the mobile communication device 104 is determined to be no longer in motion and the routine 600 proceeds to block 620 (FIG. 6C). Alternatively, if minimum movement has been detected based on the set of inputs, the routine 600 remains in an in-flight transit state and the routine 600 returns to block 636. In all the decision alternatives involving a change in transition state, the mobile communication device 104 transmits updated context information to the communication management component 102 indicative of the change in transit state.

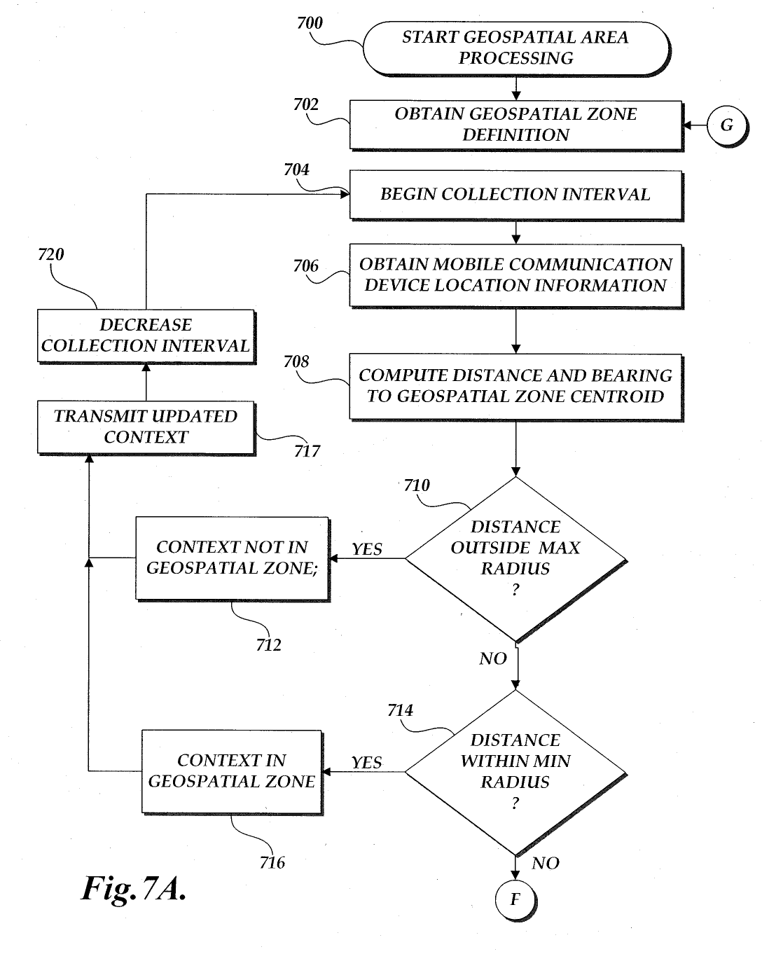

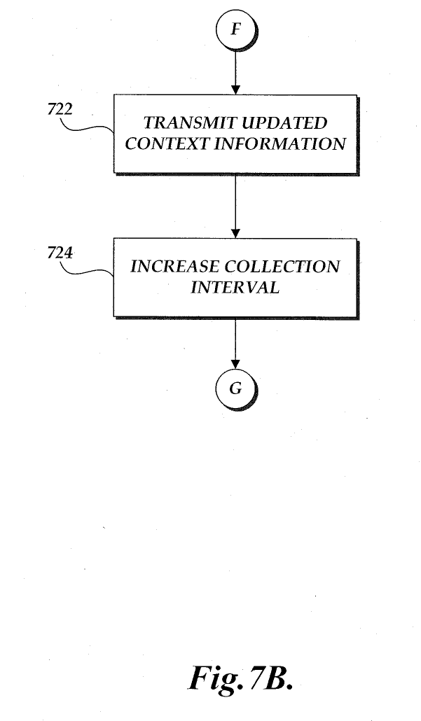

With reference now to FIGS. 7A and 7B, a routine 700 implemented by the mobile communication device context processing component 304 for determining mobile communication device geospatial context information will be described. In an illustrative embodiment, geospatial information may be defined for a geographic region. The geospatial information can include a centroid, which corresponds to an approximation of the geospatial region's central position. The centroid can be defined in terms of a longitude and latitude, x and y coordinates in a grid-type layout or other position coordinates. The geospatial information can also include a minimum radius distance that corresponds to a minimum radius that is within all boundaries of the geospatial region. The geospatial information can further include a maximum radius that corresponds to a maximum radius that is beyond all boundaries of the geospatial region. One skilled in the relevant art will appreciate that the contours of boundaries of a geospatial region can be defined in terms of a radius distance plus bearing from the centroid.

With reference to FIG. 7A, at block 702, the mobile communication device context processing component 304 obtains the geospatial region definitions from the mobile communication device context data store 307. The geospatial region definitions may be stored and maintained in a variety of formats and storage media. Additionally, the geo spatial region definitions may be prioritized in terms of order of processing by the mobile communication device 104. At block 704, the mobile communication device environment interface 306 begins a collection window in which a geospatial zone definition is evaluated to determine whether the mobile communication device 104 is within the zone. As described above with regard to transit state context assessment algorithms, the observation window can be configured such that the mobile communication device 104 collects a fixed number of sets as defined by an information collection interval over a time period. Each time a set of inputs is collected a counter is decremented and the process continues until the targeted number of sets on inputs have been collected (e.g., the counter is decremented to a value of “0”). Additionally, if the mobile communication device environment interface 306 is currently not receiving inputs, or otherwise not accepting inputs, the mobile communication device 104 may enter a lower power consumption mode in which one or more components of the mobile communication device 104 become inactive or enter in a low power consumption mode of operation. In turn, the mobile communication device 104 then powers up, or wakes up, at the next information collection interval. The specific information collection interval implemented by the mobile communication device context processing component 304 may be dependent on the granularity of the sensor information, the amount of input information that should be collected for a given transit state, and/or the likelihood of a potential change in transit state. For example, a longer collection interval can be set for transit states in which variations in the set of inputs is not expected to further conserve mobile communication device power.

At block 706, the mobile communication device context processing component 304 obtains mobile communication location information. In an illustrative embodiment, the mobile communication device environment interface 306 can obtain various sensor information indicative of a location or relative location of the mobile communication device 104, including NFC-sensor information as described above. In another example, the mobile communication device environment interface 306 can interface with a vehicle's navigation system to obtain location information. In still another example, the mobile communication device environment interface 306 can interface with wireless communication equipment, such as cellular base stations, wireless network nodes (e.g., WiFi and WiMax network nodes), and obtain location information. Additionally, the sensor information can include accelerometers and compass information that facilitates a bearing or direction of the mobile communication device.

In an additional embodiment, and as illustrated in FIG. 9, the mobile communication device environment interface 306 can associate location meta data with known signals from wireless transmitters such that a detection of a signal can provide an indication to the mobile communication device environment interface 306 of the relative location of a mobile communication device 104. As explained above with regard to routine 700 (FIGS. 7A-7E), as a mobile communication device 104 travels, signals from specific transmitters are detected when the mobile communication device is within range of the transmitter and no longer detected when the mobile communication device is beyond the range of the transmitter. In embodiments in which the mobile device detects signals from the same wireless transmitters, the mobile communication device environment interface 306 can associate location meta data obtained from another location source (such as a GPS component) to the information indicative of the wireless transmitter, such as a WiFi SSID. Accordingly, in conjunction with the known range of the wireless transmitter, the mobile communication device environment interface 306 can estimate range, associate the location meta data as the approximate location of the mobile communication device 104 for purposes of evaluating context according geospatial zones.

For purposes of power consumption, the mobile communication device environment interface 306 can monitor various location sensors/inputs. The mobile communication device environment interface 306 can prioritize or rank the location information sources based on various factors, including degree of confidence in the accuracy of the location information, power consumption associated with collecting the location data, financial or service contract issues, and the like. For example, assume that a mobile communication device environment interface 306 has previously stored location information for a known NFC-sensor associated with a building metadata in the manner described above. Although location information may also be available for an attached GPS component, operation of the GPS component consumes much more device power. Accordingly, the mobile communication device environment interface 306 could choose to receive/use location information from a source with the least power consumption metrics.

With reference again to FIG. 7, at block 708, the mobile communication device context processing component 304 calculates the distance and bearing of the current location of the mobile device to the centroid of geospatial zone. At decision block 710, a test is conducted to determine whether the distance to the centroid is outside of the maximum radius defined for the geospatial zone. If so, at block 712, the mobile device's current context is outside the geospatial zone. The routine 700 then proceeds to block 717, which will be described below.

If at decision block 710, the distance to the centroid is not outside the maximum radius, the mobile communication device context processing component 304 will then determine whether the mobile communication device is clearly within the geospatial zone or on the fringe of boundary of the geospatial zone. At decision block 714, a test is conducted to determine whether the distance is less than the minimum radius defined for the geospatial zone. If so, at block 716, the mobile device's current context is inside the geospatial zone. The routine 700 then proceeds to block 717.

At block 717, the mobile communication device 104 must transmit updated context information if a context state has changed. Accordingly, if the mobile communication device has not changed from outside the geospatial zone (block 712) or within the geospatial zone (block 716), no update will be provided. At block 720, the interval for collection of location information and the evaluation of the proximity to the geospatial zone will be decreased (or verified to be at a lower level). In either the case of clearly outside the geospatial zone or clearly within the geospatial zone, the likelihood of a sudden change in context decreases. For example, for a geospatial zone corresponding to an entire city, the frequency in which the mobile device would detect a change corresponding to being detected outside the citywide geospatial zone would likely be low. Accordingly, the collection interval could be adjusted in an effort to mitigate power drain associated with the collection and processing of the sensor information. The routine 700 then returns to block 704 for continued collection and processing of the information at the next collection interval.

Turning again to decision block 714, if the distance is not less than the minimum radius defined for the geospatial zone, the mobile communication device 104 is likely just within the boundary of the geospatial zone or just outside the boundary of the geospatial zone. Accordingly, the mobile communication device context processing component 304 can then determine with the mobile communication device 104 falls within or just outside of the geospatial zone. With reference to FIG. 7B, if the determined context is a change from a previous context, at block 722, the updated context information is transmitted to the communication management component 102. At block 724, the collection interval is increased (or verified to be at a higher level). In the case of neither clearly outside the geo spatial zone or clearly within the geospatial zone, the likelihood of a sudden change in context increases. Because of the potential for more likely changes in context, the interval for collection is increased. The routine 700 then returns to block 704 (FIG. 7A) for continued collection and processing of the information at the next collection interval.

### Communications Management Component Operation

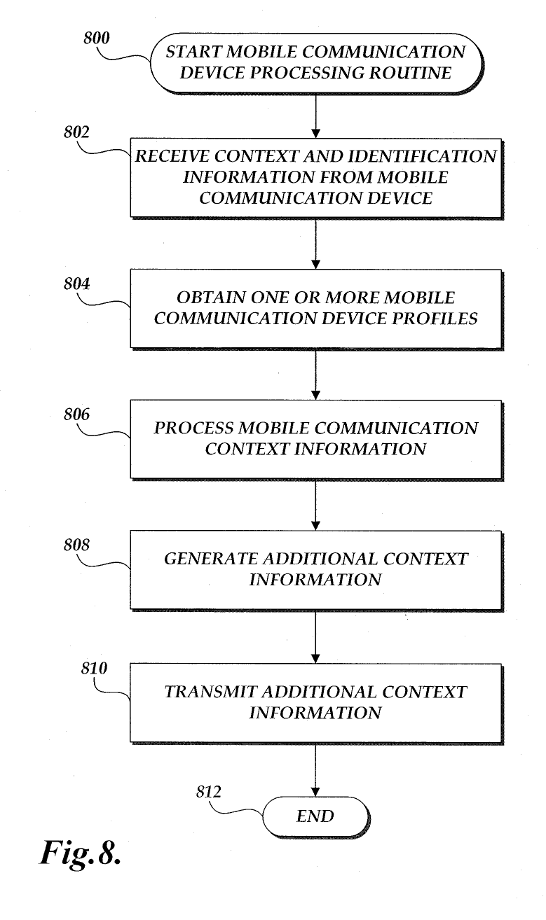

With reference now to FIG. 8, a routine 800 implemented by the communication processing component 204 to manage communications associated with a mobile communication device 104 will be described. At block 802, the mobile communication device interface component 202 receives mobile communication device context information from the mobile communication device 104. The mobile communication device context and identification information. Illustratively, the mobile communication device context information corresponds to processed inputs and is indicative of the mobile communication device context. The context information may require additional processing by the communication management system 102. As previously discussed, the mobile device communication component 102 may utilize any number of communication channels to receive the context information from the mobile communication device 104. Additionally, in the event that the context information corresponds to updated context information, especially if the mobile communication device is presently in an established communication channel, the mobile device communication component 202 may utilize alternative communication channels.

At block 804, the communication management system 102 obtains mobile communication device profile information from the mobile communication device profile store 212. As previously described, the mobile communication profile data store 212 can correspond to a database that identifies different mobile communication device profiles according to different mobile communication device context.

At block 806, the communication management system 102 processes the mobile communication device context information. In one embodiment, the communication management system 102 may utilize the selected mobile communication device profile to determine mobile communication device data availability from the context information. Based on the mobile communication device profile selected according to the context, the communication management system 102 can determine the availability to establish communication channels, establish data filters corresponding to the policy (and specified actions), or other actions.

In another embodiment, the communication management system 102 can further generate additional context information regarding the mobile communication device 104. Illustratively, the communication management system 102 can establish the current context information (e.g., a particular conference room, building, road, or other geographic identifier) to calculate directional and rate of movement over a period of time. In this example, the context of the mobile communication device 104 may not correspond to the same type of NFC-sensor. For example, a mobile communication device 104 can establish a context related to interaction with point of sale terminals, conference rooms, information kiosks, etc. that can be processed into location, directional and rate of travel information.

At block 808, the communication management system 102 generates any additional context information. The additional data associations may utilize the mobile communication device 104 context to establish additional information for delivery to third parties, such as via computing device 118. In one embodiment, the additional data associations may provide a summary of a group of individuals that may be logically associated based on proximity to one another. For example, the communication management system 102 may logically associate all mobile communication devices that are capable of interacting together via NFC-sensors. In another embodiment, the communication management system 102 may utilize additional data associations related to completed transactions at point of sale terminals or kiosks to indicate a consumer that may be in a position to make additional purchases or transactions.

At block 810, the communication management system 102 transmits the additional context information to one or more third party services. Illustratively, the context profile of mobile communication device 104 can identify privacy settings or rules that may be associated with sharing information. For example, the privacy settings or rules may establish compensation programs for sharing information or restrict access to particular third-parties or third party types. Still further, the privacy setting or rules may establish security settings for the information, such as encryption requirements or rules for eliminating types of information. At block 812, the routine 800 terminates.

While illustrative embodiments have been disclosed and discussed, one skilled in the relevant art will appreciate that additional or alternative embodiments may be implemented within the spirit and scope of the present disclosure. Additionally, although many embodiments have been indicated as illustrative, one skilled in the relevant art will appreciate that the illustrative embodiments do not need to be combined or implemented together. As such, some illustrative embodiments do not need to be utilized or implemented in accordance with the scope of variations to the present disclosure.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer-readable medium storing the computer executable components, such as a CD-ROM, DVD-ROM or network interface. Further, the component and/or data can be included in a single device or distributed in any manner. Accordingly, general purpose computing devices may be configured to implement the processes, algorithms and methodology of the present disclosure with the processing and/or execution of the various data and/or components described above. Alternatively, some or all of the methods described herein may alternatively be embodied in specialized computer hardware. In addition, the components referred to herein may be implemented in hardware, software, firmware or a combination thereof.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method, comprising:
receiving context change notification messages transmitted by a mobile communications device, at least some of said context change notification messages based on context assessments performed by the mobile communications device based on interaction with one or more near-field sensors;
maintaining state data in computer storage based, at least in part, on the received context change notification messages, wherein the state data is maintained and updated in said computer storage at least during time periods in which the mobile communications device is not being used by the user, said computer storage being separate from the mobile communications device;
receiving updated context change notification messages corresponding to the mobile communications device, the updated context change notification messages transmitted by the mobile communications device solely when a change in context is determined based on interaction with additional near-field sensors;
associating the mobile communications device with updated state data; and
determining at least one of a direction or movement vector based on processing of the context change notification message and updated context change notification messages.

2. The computer-implemented method as recited in claim 1, wherein receiving updated context change notification messages corresponding to the mobile communications device includes receiving updated context change notification messages corresponding to the mobile communications device from the mobile communications device.

3. The computer-implemented method as recited in claim 1 further comprising using at least said state data to determine whether to perform an action related to the mobile communication device.

4. The computer-implemented method as recited in claim 1, wherein the one or more near-field sensors are associated with a geographic identifier.

5. The computer-implemented method as recited in claim 1, wherein the one or more near-field sensors are associated with an active mode.

6. The computer-implemented method as recited in claim 1, wherein the one or more near-field sensors are associated with a passive mode.

7. The computer-implemented method as recited in claim 1 further comprising generating at least one additional data association based on at least one of the processing of the context change notification message or the updated context change notification messages.

8. A system for managing communications associated with a mobile communication device comprising:
a mobile communication device interface for bilateral communications with a mobile communication device, wherein the mobile communication device interface obtains mobile communication device context information, the mobile communication device context information on context assessments performed by the mobile communications device based on interaction with one or more near-field sensors;
a mobile communication device data store for maintaining mobile communication device context profiles according to specific mobile communication device contexts, wherein the mobile communication device availability is determined asynchronously; and
a communication management component for managing activity based on the mobile communication device profiles, wherein managing activity includes one of determining geographic information related to the mobile communication device or managing communication information related to the mobile communication device.

9. The system as recited in claim 8, wherein the mobile telecommunications device can be associated with two or more mobile communication device contexts.

10. The system as recited in claim 8, wherein the communication management component is further operable to receive further updated context change notification messages corresponding to the mobile communications device.

11. The system as recited in claim 8, wherein the communication management component is further operable to determine geographic information by processing a cumulative set of context change notification messages to determine location.

12. The system as recited in claim 8, wherein the communication management component is further operable to determine geographic information by processing a cumulative set of context change notification messages to determine direction.

13. The system as recited in claim 8, wherein the mobile device context is directly correlated to a detected near-field sensor.

14. The system as recited in claim 8, wherein the mobile device context is indirectly correlated to a detected near-field sensor

15. The system as recited in claim 8, wherein the mobile device context is correlated to a detected near-field sensor in combination with at least one additional sensor information.

16. A method for managing communications associated with a mobile communication device comprising:
maintaining a mobile communication device profile, wherein the mobile communication device profile defines criteria for processing data processing profiles based on a current mobile communication device context, the mobile communication device context based on context assessments performed by the mobile communications device based on interaction with one or more near-field sensors;
subsequently managing the mobile communication device based on profile associated with the current mobile communication device context, wherein managing the mobile communication device includes one of determining geographic information related to the mobile communication device or managing communication information related to the mobile communication device;
receiving updated context change notification messages corresponding to the mobile communications device, the updated context change notification messages transmitted by the mobile communications device solely when a change in context is determined based on interaction with additional near-field sensors;
modifying the management of the mobile communication device based on the updated context change notification messages.

17. The method as recited in claim 16, wherein modifying the management of the mobile communication device corresponds to processing a cumulative set of context change notification messages to determine location.

18. The method as recited in claim 16, wherein modifying the management of the mobile communication device corresponds to processing a cumulative set of context change notification messages to determine direction.

19. The method as recited in claim 16, wherein modifying the management of the mobile communication device corresponds to processing a context change notification messages to determine a violation of a policy associated with the one or more near-field sensors.

20. The method as recited in claim 16 further comprising generating at least one additional data association based on at least one of the processing of the context change notification message or the updated context change notification messages.
